(19) United States
(12) Patent Application Publication
(10) Pub. No.: US 2021/0034590 A1
(43) Pub. Date: Feb. 4, 2021

(54) LEDGER-BASED MACHINE LEARNING

(71) Applicant: JetClosing Inc., Seattle, WA (US)

(72) Inventors: Arthur C. Delight, IV, Seattle, WA (US); David Wolf, Redwood, WA (US); Charles Sullivan, Seattle, WA (US)

(21) Appl. No.: 16/941,906

(22) Filed: Jul. 29, 2020

Related U.S. Application Data
(60) Provisional application No. 62/882,112, filed on Aug. 2, 2019.

(51) Int. Cl. G06F 16/21; G06F 16/2455; G06N 20/00

(52) U.S. Cl. CPC G06F 16/219; G06N 20/00; G06F 16/24552; G06F 16/211

(57) ABSTRACT

Disclosed herein are methods and systems for use in database hosting and other systems, such as systems for real estate and other transactions with distributed clients. The methods and systems are directed to maintaining and updating core data to ensure all clients and users have correct data for the transactions. Core data is maintained and updated, in part, by use of append-only ledger systems that assigns a unique identifier to events (inputs) received from users. Such methods and system may be implemented by a cloud-based hosting service. The methods and systems may use an append-only ledger and support schema validation, subscriptions and event replay. The replay of events from the ledger may use a subscription and replay fanout tables.

### CROSS-REFERENCE TO RELATED APPLICATION(S)

This application is a nonprovisional patent application of and claims the benefit of U.S. Provisional Patent Application No. 62/882,112, filed Aug. 2, 2019 and titled “Ledger-Based Machine Learning,” the disclosure of which is hereby incorporated herein by reference in its entirety.

### FIELD

The present disclosure generally relates to methods, devices and systems for managing and maintaining databases, such as for real estate transactions. Some of the methods, devices, and systems make use of data structures that include append-only ledgers to maintain accurate information. These embodiments support schema validation, subscriptions, and event replay.

### BACKGROUND

Many companies and commercial operations may need to use, maintain, and access large amounts of data. Efficient and timely access to such data is important for representatives of such companies, such as when interacting with clients or customers. The data may be stored and maintained on computer hardware and systems operated by third party firms, such as web-based hosting and cloud computing firms. The data may be stored in a database to allow for access, searching, queries, additions, deletions, and the like.

The data in the databases may need to be updated and also supplied to one or more clients. Updating data may create issues related to maintaining accuracy of the data, and ensuring the clients or users are provided with accurate data, especially when the clients are remote from, and interacting individually with, a host computer system. For example, data regarding a real estate transaction (e.g., addresses, loan amounts, realtor information, and/or owner and buyer information) may be stored in a database at a web-based hosting service. As there may be multiple parties or clients to a single real estate transaction, there may be multiple inputs from multiple clients with one or more data updates, or with one or more queries for data. Errors can arise if the database is not updated with new or corrected information before such information is provided to another client.

It may be that, when multiple clients are in communication with a hosting service, each client is queried by the hosting service to ensure that each client is referencing the most recently updated version of the database. However, this can add latency to the interactions between the clients and the hosting service. The latency may be unacceptable from a user's point of view, may delay transactions, may cause data to be inaccurate, and so on.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

The embodiments disclosed herein are directed towards methods, data structures, devices, and systems for use with a database. Such embodiments may be used with a database maintained and used by a real estate agent or company for completing real estate transactions with one or more users or customers.

More specifically, in one aspect, methods of operating a hosting service are disclosed. The methods include receiving multiple input events, validating each of the received input events, providing an absolute ordering of input events of the received multiple input events having the same partition key, providing a respective naming pattern to each of the received input events in which the naming pattern includes the partition key, and appending the input events to an append-only ledger as archived events using the naming pattern.

Additionally and/or alternatively, the append-only ledger may be implemented as a write-once-read-many ledger, and the naming pattern may be provided by an archiver program. The methods may include maintaining a schema cache and a subscription cache. As used herein, an “append-only ledger” refers to a database, whether centralized or decentralized, having a write-once-read-many property. In such a database there are no deletes of entries or changes of the data.

The methods may validate each of the received events by validating that each received event is well-formed, retrieving a respective schema corresponding to each received event from the schema cache, and validating respective data of each received event against the retrieved respective schema. The methods may include dispatching events from the append-only ledger to clients. Dispatching events may include reading subscription information from the subscription cache, determining which of the clients are to receive the events, and determining which of the events are to be dispatched. The subscription information may include any of: a client name, a subscription name, one or more subscribed events, a handler type, a handler address, and a subscription state.

The method may also include updating at least one of the schema cache and the subscription cache according to instruction data.

In another aspect, systems are disclosed for maintaining an event-based database hosting service. In one embodiment, such a system may include an input module configured to receive input events. As used herein, a “module” refers to a computing service or program that runs code and/or manages the computing resources of the hosting service required to run such code. The hosting service may further include an append-only ledger configured to store or archive the input events in a memory of the hosting service as archived events. The system may include a non-transitory storage medium that stores instructions that may control how a processor or other computational components function, and an output module configured to dispatch the archived events stored in the append-only ledger. The processor may be communicatively linked with the input and output modules, the memory and the append-only ledger, as well as to other elements of the system. When the stored instructions are executed on the processor, the system may: receive input events on the input module, validate each of the input events, provide an absolute ordering of the input events, and append the input events as archived events to the append-only ledger according to the absolute ordering.

The absolute ordering of the input events may be based on a naming pattern that includes a partition key and a monotonically increasing identifier, and may be provided by an archiver program that appends the input events with the naming pattern to the append-only ledger.

The system may include a schema cache and a subscription cache. The system may validate each of the received input events by: validating that each received input event is well-formed, retrieving a respective schema corresponding to each received input event from the schema cache, and validating respective data of each received input event against the respective retrieved schema.

The system may select archived events from the append-only ledger, and dispatch the selected archived events to clients. These actions may include reading subscription information from the subscription cache, selecting the archived events to be dispatched using the subscription information, and determining to which of the clients the selected archived events are to be dispatched. The subscription information may include: a client name, a subscription name, one or more subscribed events, a handler type, a handler address; and a subscription state. The system may update at least one of the schema cache and the subscription cache using instruction data contained in at least one input event.

### BRIEF DESCRIPTION OF THE DRAWINGS

The disclosure will be readily understood by the detailed description in conjunction with the accompanying drawings, wherein like reference numerals designate like structural elements.

FIG. 1 illustrates a block diagram of a hosting service in communication with clients, according to an embodiment.

FIG. 2 illustrates a block diagram of a hosting service and certain components, according to an embodiment.

FIG. 3 illustrates a block diagram of a hosting service that includes a ledger, according to an embodiment.

FIG. 4 is a flow chart of a method of operating a hosting service, according to an embodiment.

FIG. 5 is a flow chart of a method of validating an input event, according to an embodiment.

FIG. 6 is a flow chart of a method of dispatching an archived event to a client, according to an embodiment.

FIG. 7 is a flow chart of a method of updating caches, according to an embodiment.

FIG. 8 is a flow chart of a method for replaying a ledger to a client, according to an embodiment.

FIGS. 9A-E illustrate an example of the method of FIG. 8.

It should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The embodiments described herein are directed to methods, devices, and systems, such as web-based database hosting services (or simply “hosting services”), that communicate and interact with multiple clients or users. The hosting service may be cloud based, and be implemented over multiple connected sites and nodes. Such hosting services often maintain one or more databases with client information. The information in the databases may need to be updated and also supplied to one or more clients. In the example of a company providing real estate transaction services, sample information stored in one or more databases, and that may be provided to clients, include client personal information, contract information that is being updated or revised, geographical information regarding a real property, current loan rates, and so on.

Continuing with this example, the company that provides real estate transaction services may use a cloud- or web-based hosting service for its operations. These operations may include maintaining one or more databases containing information about various properties, buyers, sellers, and agents, and copies of documents related to the real estate transactions. The operational structure may be that of a host computer system (e.g., a server) communicating with multiple client devices operated by users (or “clients”), such as buyers, sellers, agents, loan officers, and so on. The operations may include receiving and validating inputs from clients, updating databases, and providing information from the databases to the clients.

Though the methods and systems disclosed herein will be described in relation to this example, one skilled in the art will recognize that the methods and systems may be used and implemented in other business activities that make use of web- or cloud-based hosting services.

There may be multiple parties (users or clients) to a real estate transaction, who may be in separate locations and entering and/or receiving information from the hosting service at the same time, or nearly the same time. This may create issues or problems with ensuring that each client has the most current information. For example, an agent may need to know a seller's most recent asking price to relay to a buyer, or to complete an on-line form for a buyer. In another example, a buyer may need to inform an agent or seller about a change of legal address.

Such interactive situations make it advantageous for the hosting service to have a way to ensure a clear “source of truth” about the information in the databases. One way this may be done is to allow only one party to update or access the information in the hosting service at a time. While functional, this method can add latency to the response of the hosting service to inputs and queries from the various users.

The embodiments disclosed herein may make use of an event-based procedure or paradigm. In these embodiments the databases of the hosting service may accept inputs from clients, or other forms of input, such as messages from other modules in the hosting service. All such accepted inputs are referred to herein as “input events.” The hosting service may apply an absolute ordering of the input events and the information contained therein. This absolute ordering is then maintained in part by storing (or “archiving”) the input event, together with unique identification information, in an append-only ledger maintained by the hosting service. The append-only ledger can be implemented as a write-once-read-many database.

When the hosting service transmits information to a client, the correct information is inferred using the absolute ordering that was applied to the input events. In this way the various clients or users know the information is the correct and current.

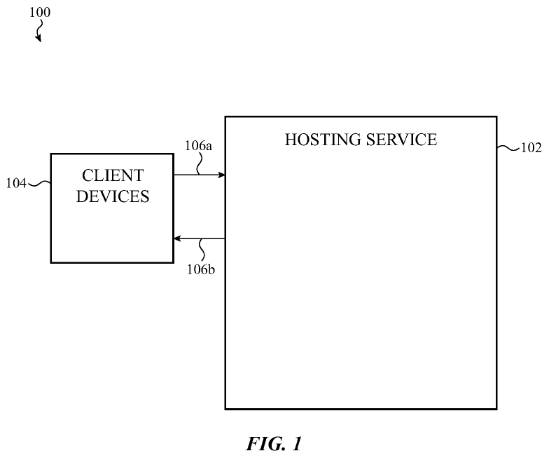

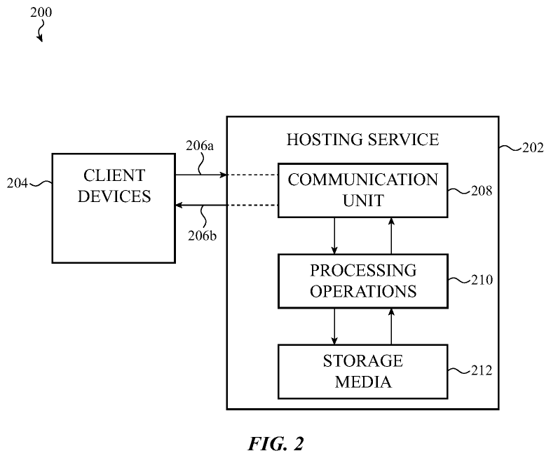

These and other embodiments are discussed below with reference to FIGS. 1-9E. However, those skilled in the art will readily appreciate that the detailed description given herein with respect to these figures is for explanatory purposes only and should not be construed as limiting.

FIG. 1 illustrates a block diagram of a system 100 including a hosting service 102 that can be accessed using client devices 104, as may be implemented in various embodiments. The hosting service 102 may be a web-based hosting service, which the client devices 104 may access through an internet connection. Such a connection may be either wired or wireless.

The hosting service 102 may accept input communications 106a from client devices 104. Such input communications 106a may include updates of data from one of the users of the client devices 104 to be stored at the hosting service 102, queries (requests) from one of the users of client devices 104 for data maintained at the hosting service 102, or another communication. The hosting service 102 may allow for concurrent access by multiple client devices 104.

The hosting service 102 may provide information to one or more client devices 104 via response communications 106b. The response communications 106b may contain requested data, may be a response to a query, or another communication. The information may be supplied through a wireless (e.g., cellphone) connection or through a wired (e.g., landline twisted pair, coax or fiber cable, etc.). The information may be encrypted, either by the hosting services or the clients.

In one example, a real estate transaction company may use a third party company to provide a web-based hosting service to provide services to its customers (in this example, the client devices 104). The real estate transaction company may make use of the third party company to store, and provide access to, information related to real estate transactions, for example, buying/selling of a house. The web-based hosting service can then provide access to both the buyer, the seller, an agent or broker, or another client with an interest in the sale. The web-based hosting service provided by the third party company may maintain the information related to the sale of the house and accept updates to it as needed.

FIG. 2 illustrates a block diagram of a system 200 including a hosting service 202 that can be accessed using client devices 204. The hosting service 202 may be used by a particular business entity or company to provide its services to customers. The hosting service 202 may be implemented by a third party company that owns and maintains servers, computing systems, databases, internet access and telecommunications equipment, and the like that it commercially provides to the business entity.

Each client device 204 may be any type of electronic device having communication equipment through which it can access the hosting service 202. Such access may be by wired or wireless internet connection, one example of which is a telecommunications link. The hosting service 202 may include a communication unit 208 that provides the communication link or links through which the client devices 204 access the hosting service 202. Examples of such links include cable, twisted pair or fiber optic links, WiFi links, cellular telecommunication links, and other types of communication links.

The communication unit 208 may receive input communications 206a from the client devices 204, and may provide any needed initial demodulation and formatting of information contained in the input communications 206a. The communication unit 208 may also be configured to transmit output communications 206b to the client devices 204, such as by applying any need coding, modulation, or other formatting to form and transmit the output communications 206b.

The communication unit 208 may transmit or relay information received in an input communication 206a to a processing operations module 210. As used herein, a “module” may refer to a computing service or program that runs code and/or manages the computing resources of the hosting service required to run such code. A module may itself use or implement other modules. The processing operations module (or simply “processing module”) 210 may be implemented by one or more computers, computing systems, processors, and the like. The processing operations module 210 may be include separated components that are communicatively linked.

The processing module 210 may perform various operations based on the information received from an input communication 206a. Such operations may include performing a calculation, storing the information, retrieving other information, and the like.

The processing operations module 210 may store information in a database, or in another storage format, in storage media 212. The storage media 212 may be disk storage media, such as solid state or magnetic recording media, or another form of storage that may be accessed by the processing operations module 210. The storage media may be: a standalone device, multiple storage devices stored in a central server location, stored remotely from a server center performing the hosting services, and may be include distributed storage.

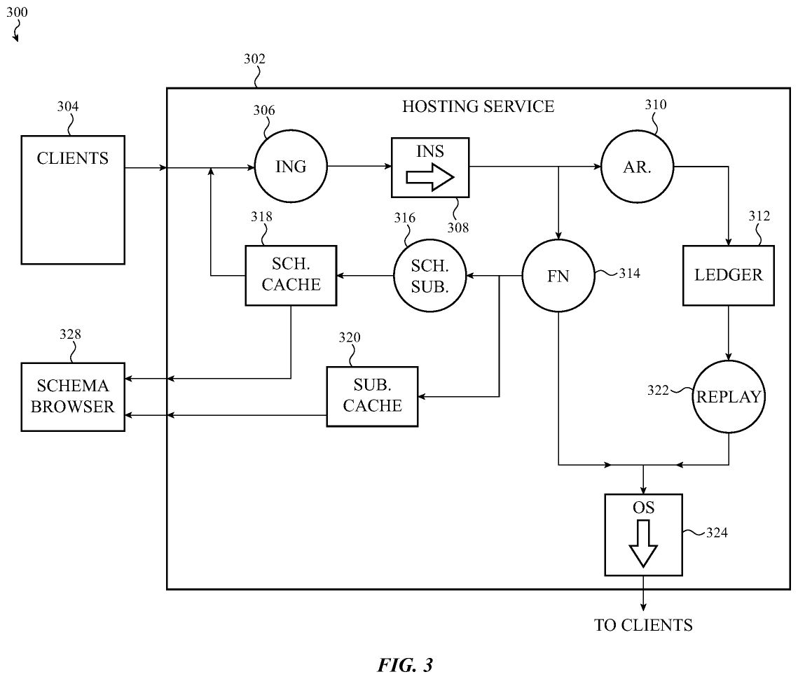

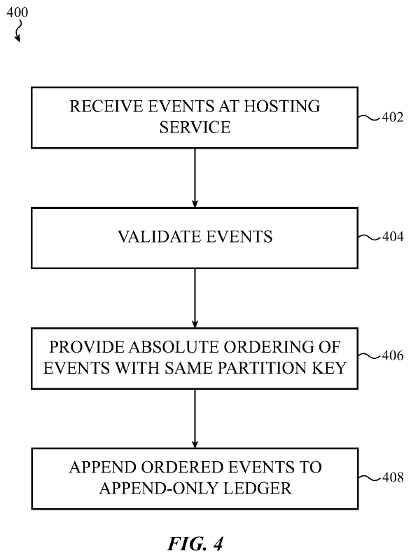

The configurations and systems shown in FIGS. 1 and 2 may be implemented with the particular types of components and system configurations described in relation to FIG. 3 to implement the methods described below in relation to FIGS. 4-9E. In some embodiments, the components described in FIG. 3 may be virtual operations or programs run or implemented by processors, processing units, or computing nodes (or the like) of the hosting service and having access to databases stored in memory, such as temporary electronic memory (such as RAM) or non-volatile or non-transitory memory (such as hard disk memory or another type).

FIG. 3 illustrates a particular configuration of a system 300 of a hosting service 302, such as may be used in various embodiments. The configuration of the components of the hosting service 302 is adapted to implement the method of operation described below in relation to FIG. 4. However, it will clear to one skilled in the art that the hosting service 302 may implement other methods of operation, and may have other configurations.

The hosting service 302 is communicatively linked with client devices 304. The client devices 304 may communicate with the hosting service 302, such as by using client devices 104 or 204 as described above. The communication link may be by internet or another connection technology. The hosting service 302 may be able to link with multiple client devices 304 simultaneously.

The hosting service 302 performs reception of communications from the client devices 304 by an Ingress function or module 306. The Ingress module 306 may include any signal reception and demodulation components, or may operate on the formatted output of such signal reception equipment.

Certain received communications from client devices 304 are considered as input events. Included as input events are inputs from client devices 304 containing new information for recording into or updating of a record or database, such as information related to a real estate transaction. Input events may also include authentication or consensus requests between nodes of a distributed database. The information may be formatted according to a particular type of database format. For example, an agent may send a buyer's name, address, and other identifying information, using a particular database or document format. Other inputs from client devices 304 that can be considered as input events are queries from the clients for information from one or more databases maintained by the hosting service 302.

The input or Ingress module (ING) 306 may perform validation of the received input events. Validation may include password or other security checking, checking syntax and spelling errors, and determining a schema (or database format) for the received input event. Further details of validation are presented below in regard to the method 400 in FIG. 4.

Once inputs event have been validated, they are then added to the Ingress Stream (INS) module 308. The Ingress Stream module 308 may perform partitioning of the input events or the data therein. The Ingress Stream module 308 then may apply an absolute ordering of all input events with the same partition key. (The partition key provides an identifier for rows (or columns) of the partitioned input events or data.) The Ingress Stream module 308 may accomplish the absolute ordering by using the partition key and additionally assigning a monotonically increasing sequence of identifiers (IDs) to all incoming input events with the same partition key. As an example, such IDs may have thus have a naming pattern that includes the form: shard_ID+Incremental_int for partitioning of the input events based on shards, with shard_ID being a particular case of a partition key. Thus the partition key provides a first stage or step of the absolute order, with the monotonically increasing identifiers, Incremental_int providing the second step. Further details of how the Ingress Stream module 308 assigns the monotonically increasing sequence of IDs are presented below in regard to the method 400 in FIG. 4.

After the Ingress Stream module 308 has assigned the sequence of IDs to the input events, an Archiver (AR) 310 may archive or add all input events from the Ingress Stream module 308 into an append-only ledger 312. Generally, the Archiver functions to access a memory of the hosting service 302 containing the append-only ledger and add the input events with their naming patterns to the append-only ledger 312. The naming patterns just described allows archived (or “stored”) events in the append-only ledger 312 to be replayed at high speed while maintaining absolute ordering for a given partition key.

The append-only ledger 312 may be implemented as a write-once-read-many database. In some embodiments, the append-only feature of append-only ledger 312 may be implemented as an Object Lock legal hold. Such an Object Lock, or an equivalent control, allows only one thread, when multiple threads are running on the processing module, to have access to data or information in the ledger. This can ensure that the ledger remains as an ultimate source for correct and/or most current data.

The hosting service 302 includes various components (or implemented functions, or modules performing the functions) configured for sending (or “dispatching”) one or more archived events (or their information) from the append-only ledger to client devices 304. These include a fanout (FN) module 314. The fanout module 314 reads subscription information from a subscription cache 320. The fanout module 314 can determine which of client devices 304 is to receive which archived events. The fanout module 314 may instruct an output system (OS) 324 for sending one or more archived event to the corresponding client device 304.

The hosting service 302 may also include a schema subscriber (SCH SUB) 316. The schema subscriber 316 may be configured to detect input events with the object schema.* and/or subscription.* For such objects, the schema subscriber 316 may update, respectively, a schema cache 318 and a subscription cache 320.

The subscription cache 320 may contain tables or databases for subscriptions. A subscription may include: a client name, a subscription name, one or more subscribed archived events, a handler type, a handler address, and a subscription state.

The hosting service 302 may also include a replay module 322. The replay module 322 may be invoked by the schema subscriber 316 when a subscription is created or updated to one of the replay statuses. The hosting service 302 may make use of the replay module 322 to resend the append-only ledger 312, either in part or in its entirety, to one of the client devices 304. The replay module 322 may send instructions to an output module or system (OS) 324 for sending the ledger to a client device 304.

Sending a ledger to a client may be used, first, when a new cache needs to be populated initially. A second use is if a client was offline and needs to receive updates or archived events from the ledger. A third use is in case a development (dev) cache needs to be populated.

In addition to the client devices 304, the hosting service 302 may be accessed by a schema browser 328. The schema browser 328 may be configured as a user interface for documentation of schemas and schema versions.

Details of methods of operation the various components of the hosting service 302 will now be presented. One skilled in the art will recognize that the hosting service 302 may use additional and/or alternative methods, and that the methods described below may be implemented by hosting services have structures and configurations distinct from that shown in FIG. 3.

FIG. 4 is a flow chart for a method of operation 400 that may be implemented by a hosting service, such as the hosting service described in relation to FIG. 3. The method of operation 400 may be implemented at a web- or cloud-based computing and data storage facility. Such a facility may comprise various types of computing hardware, data storage media and other components. Such a facility can be provided with internet and telecommunication links for user access.

At stage 402 the hosting service receives one or more input events from one or more clients or other sources. The reception may be over an internet connection, by telecommunications network, or by another means.

At stage 404 each the received input event is validated, such as by the Ingress function or module 306 described above. Validation of an input event may include determination that the input event is well-formed, such as having a correct format and being free of syntax errors.

Validation may also include a determination of a database schema corresponding to the input event. This may be necessary since various clients may use different database formats or other programs to contain the information or request sent to the hosting service. Once the corresponding schema for the input event has been determined, that schema can be obtained from a schema cache, such as the schema cache 318, maintained by the hosting service. The input event is then checked according to the retrieved database schema.

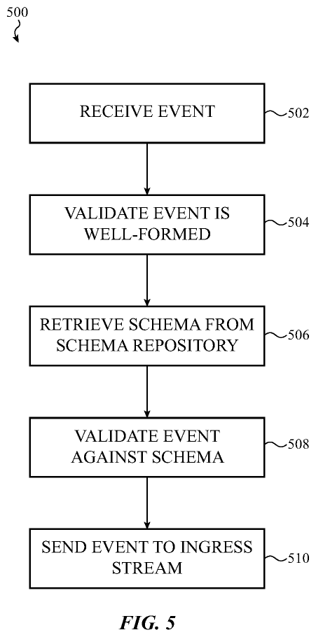

If a problem with the input event is detected during checking, an error or other notification may be sent to the client's device to inform the client of the problem. The input event may then not be passed to further operations. When no problems with the input event are detected, the input event may be added to an input stream or queue of input events, such as the Ingress stream module 308, for further operations. Such further operations may include partitioning information of the input event. Further details of the validation operations are described below with respect to FIG. 5.

At stage 406 the hosting service provides an absolute ordering of input events with the same partition key. The absolute ordering can be provided by operations such as those of the Ingress stream module 308. The Ingress stream may be a collection of persistent first-in, first-out (FIFO) streams (or “shards”). The input events are divided among the shards by a hash of the input event's partition key. The Ingress stream module 308 synchronously assigns monotonically increasing identifiers (“IDs”) to all incoming input events. Such IDs may be composed with the form shard_ID+Incremental_int. The shard_ID increments with the addition of new shards so that even during a re-sharding action, all input event identifiers are monotonically increasing and absolutely ordered for a given partition key.

To guarantee absolute ordering in processing the input events from the stream, the Ingress Stream module 308 does not spawn more than one concurrent instance of a handler process (or “anonymous function”) for each shard. Since a shard will be read by one process at a time, recipients of the downstream processes or fanout targets are thus guaranteed that they will receive input events in ascending event ID order.

At stage 408, the input events are archived to an append-only ledger, such as append-only ledger 312, by an archive operation, such as Archiver 310. An input event may be archived by using a naming pattern including the form or elements partitionKey/IngressID. This may allow the archived events to be replayed from the ledger at high speed while maintaining absolute ordering for a specific partition key. The append-only ledger may be a write-once-read-many storage structure that stores data and its descriptive metadata. To ensure that the ledger is append-only, an object lock can be implemented, as described above.

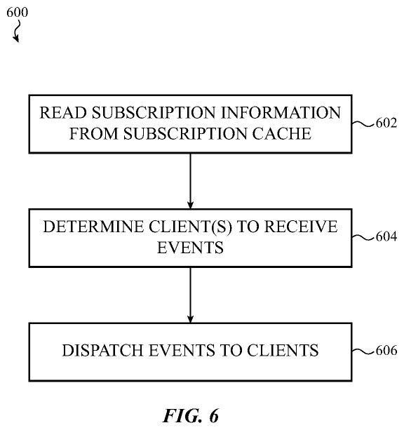

When it becomes necessary to rebuild a database or create a new one, the archived events in the append-only ledger can be replayed or read out at high speed to a fanout target. Further details of operations related to replaying or dispatching an archived event to a consumer or client are described below with respect to FIG. 6.

FIG. 5 is a flow chart of a method 500 for validating an input event that may be performed in certain embodiments. These operations may performed at stage 404 of the method described with respect to FIG. 4, and may be performed by the Ingress module 306 described with respect to FIG. 3.

At stage 502, an input event is received, such as from a communication unit 208 from a client device 204. The communication unit 208 may convert the physical signal to digital format accepted by the hosting service.

At stage 504, validation of an input event may include determining that it is well-formed. This may include checking for typographical or syntax errors, and then determining the corresponding schema of the input event. If initial problems or errors are detected, an error or alert message (such as a request to resend) may be transmitted to the user's client device.

At stage 506, the corresponding schema is obtained from a schema repository maintained by the hosting service. This operation may include retrieving the corresponding schema from a more-slowly accessed memory (such as tape or disk memory system) and loading it into more rapidly accessed memory of the processing units (such as RAM or cache).

At stage 508, the received input event checked to be in accord with the retrieved schema. Again, if a problem or error is detected, an alert message may be sent to the user's client device. If no problem or error is detected, at stage 510 the input event can be included in the Ingress stream of input events. A validation flag may be included with the input event when the input event is appended to the Ingress stream.

FIG. 6 is a flow chart of a method 600 that may be used by a hosting service to dispatch archived events, or their information, to consumers, who may be using the client devices 304. In the system 300, the operations of the method 600 may be used by the fanout module 314.

At stage 602, the subscription information for an archived event is read from a subscription cache maintained by the hosting service.

At stage 604, information obtained from the subscription cache can be used to correlate which consumers (clients) should receive which archived events.

Then at stage 606 the archived events are dispatched to the respective consumers or clients. The archived events may be dispatched by transmissions performed by communications equipment, such as communication unit 208.

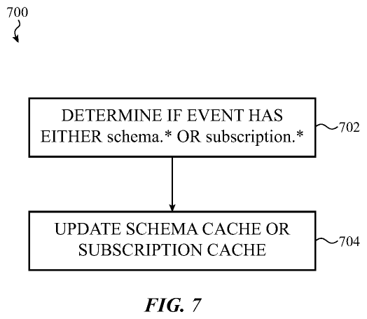

FIG. 7 is a flow chart of a method 700 that may be used by a hosting service for updating the schema cache and the subscription cache maintained by the hosting service. The updating may be performed by a schema subscriber, such as schema subscriber 316 of FIG. 3.

At stage 702, an input event is read, such as by schema subscriber 316, to determine that the event includes a schema to be updated, or that the event includes subscription information to be updated. This may be determined by the presence of indicators flags in the input event.

At stage 704, once it is determined that the event does include a schema, or does include subscription information, respectively the schema cache or the subscription cache is updated.

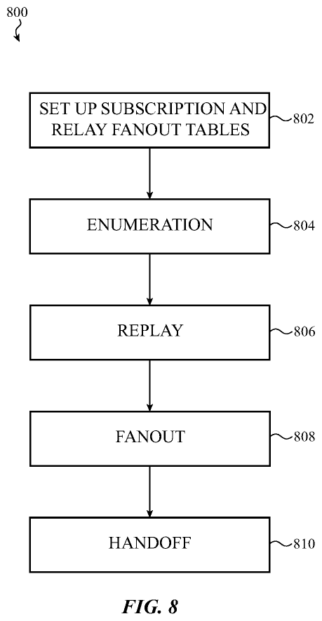

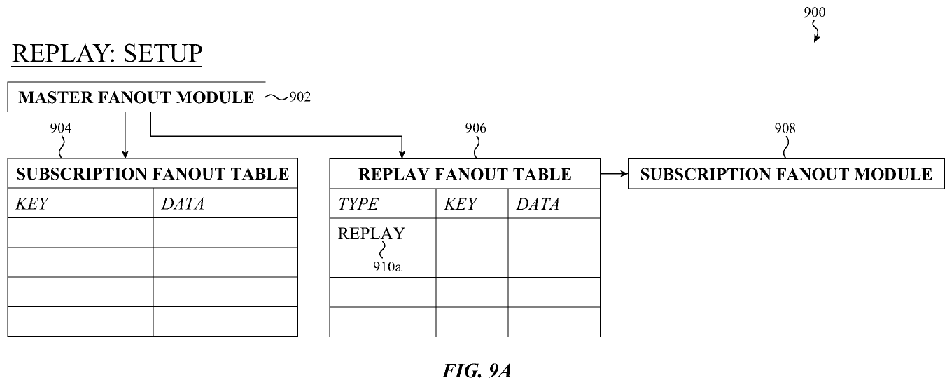

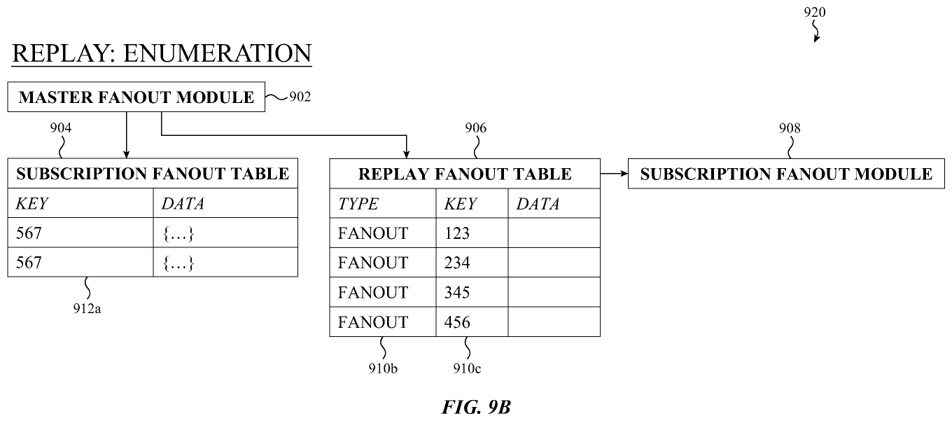

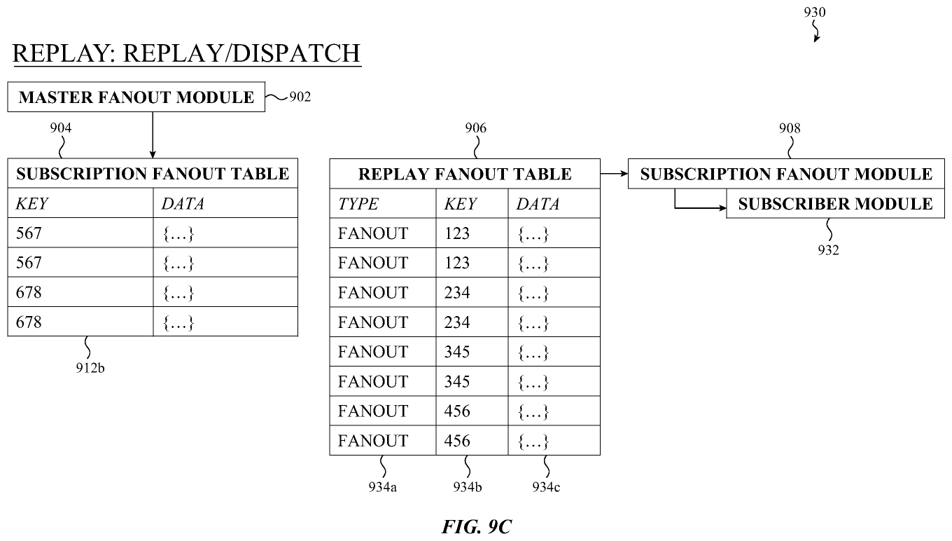

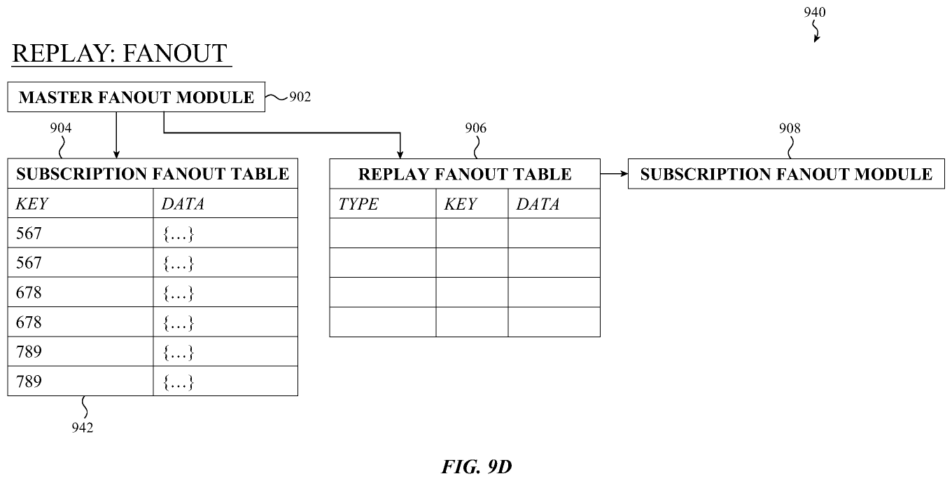

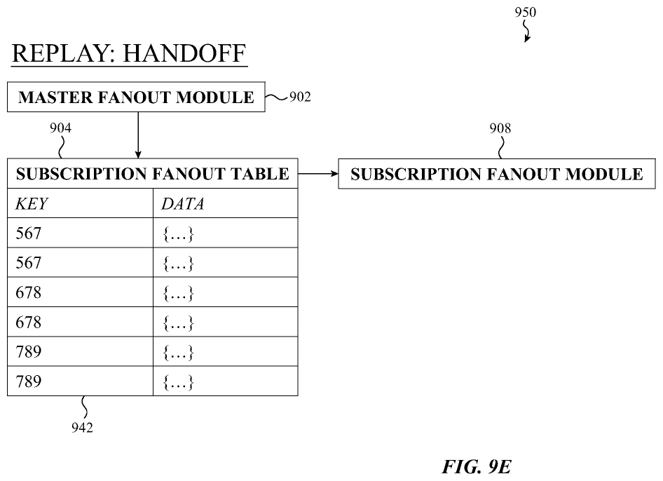

FIG. 8 is a flow chart of a method 800 that may be used by a hosting service to replay or dispatch archived events from an append-only ledger to clients or users. The method 800 may be implemented within the hosting service 302 using the fanout module 314 together with the replay module 322, to replay and/or dispatch archived events stored in the append-only ledger 312. The method 800 may be one method for implementing stage 606 of the method 600 described above. FIGS. 9A-E show a simplified example 900 of states of the system during an implementation of the stages of method 800 and will be discussed concurrently with certain stages of the method 800 as illustrations thereof.

The method 800 begins at stage 802 with a setup of a subscription fanout table and an associated replay fanout table. These two tables may be set up or created by a master fanout module of the hosting service 302 upon receiving a validated client request. For example, if the system is provides real estate sales services for multiple properties, a realtor (client) may send a request for the latest updated information regarding a pending sale of a house. With regard to FIG. 9A, the master fanout module 902 invokes the subscription fanout table 904 and replay fanout table 906. All the archived events sent by the master fanout module 902, whether entered into the subscription fanout table 902 or the replay fanout table 906, ultimately or eventually is processed and sent.

Stage 802 may also include a setup of a subscription fanout module to replay or dispatch the fanout table data. A master fanout module sends archived events into a subscription fanout table, which can provide a buffer of incoming archived events while the fanout operations are performed using a replay subscription table. A subscription fanout module is associated with the replay fanout table, and a REPLAY record is inserted into the replay fanout table. FIG. 9A shows an example 900 of a state of the system. The subscription fanout module 908 is associated with the replay fanout table 906, and the REPLAY record 910a is inserted as a TYPE in the replay fanout table 906.

Stage 804 is an enumeration stage; one partition key record is inserted into the replay fanout table for each partition key to be replayed. The subscription fanout module then reads the replay fanout table. That is, upon detecting a REPLAY record, the subscription fanout module reads every partition key in the system, and writes back into the replay fanout table with partition key records. Each partition key record may be implemented as an element in a first-in-first out (FIFO) queue, and there may be an instance of the subscription fanout module running for each partition key. However, the number of such running subscription fanout modules generally does not exceed the number of partition keys. The REPLAY record may then be deleted so that the subscription fanout module will proceed to with the actions of stage 806. In the example 900 shown in the enumeration state 920 of FIG. 9B, four KEY records 910b are inserted, along with identifiers 910c, into the replay fanout table 906. While this is occurring, the subscription fanout table 904 is populated or buffered with arriving archived events 912a sent by the master fanout module 902.

At stage 806, the replay fanout table is further filled for dispatching to a client or other end user. The subscription fanout module (or each instance thereof) restarts reading the replay fanout table. For each partition key record, the subscription fanout module enumerates each partition key with its archived events and their data, i.e., the subscription fanout module writes back to the replay fanout table. For each partition key record, one FANOUT record is inserted into the replay fanout table for each archived event matching the partition key. An end-of-key record is inserted into the replay fanout table for the current key, and the KEY record is deleted.

The results of these actions are shown in FIG. 9C as stage 930 of the example 900. In the subscription fanout table 904, further keys 912b have been arriving (such as from the master fanout module 902) and are buffered. For the first partition KEY record “123” previously inserted in the first row of the replay fanout table 906, there were two corresponding archived events, so two FANOUT records (with exemplary labels 123), keys, and data respectively inserted into the Type column 934a, the Key column 934b, and the Data column 934c of the replay fanout table 906. Similarly, in this example, for each of the other partition KEY records 910b, there were two corresponding archived events, so two FANOUT records, keys, and corresponding data are inserted in rows of the replay fanout table 906.

At stage 806, the subscription fanout module can use or generate a related subscriber module. At stage 930 of the example 900, the subscription fanout module 908 associates to the subscriber module 932.

At fanout stage 808 of method 800, which may be implemented by the subscriber module 932, the information or data of the archived events in the replay fanout table 906 is dispatched or transmitted to the client. As a line of the replay fanout table 906 is read, if the current FANOUT record is an archived event, it is sent to the client. Alternatively, if the current FANOUT is an end-of-key, the current record is deleted from replay fanout table, or if the table count is zero, the subsequent handoff stage 810 of the method 800 is initiated.

In the example 900, the result of stage fanout 808 is shown as stage 940 in FIG. 9D. The replay fanout table 906 has been emptied (i.e., the table count has reached zero). The subscription fanout module 908 has deleted the subscriber module 932. The subscription fanout table 904 has been further populated with archived events 942 that have been buffered.

Stage 810 of the method 800 includes a handoff operation, that may be performed by a subscription fanout module. The subscription fanout module is dissociated (or ‘unsubscribed’) from the replay fanout table, and then associated with (or ‘subscribed’) to the subscription fanout table. The replay fanout table may be deleted. The archived events buffered in the subscription table may then be replayed to the client. The results of these actions are shown in FIG. 9E as stage 950 of the example 900. The subscription fanout module 908 is now associated with the subscription fanout table 904.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A method of operating a hosting service, comprising:
receiving multiple input events;
validating each of the received input events;
providing an absolute ordering of those validated received input events of the received multiple input events having a same partition key, the absolute ordering comprising a monotonically increasing identifier;
providing a respective naming pattern to the each of the validated received events, the naming pattern including the partition key;
appending the validated received input events to an append-only ledger as archived events using the naming pattern; and
maintaining a schema cache and a subscription cache.

2. The method of claim 1, wherein the naming pattern is provided by an archiver program.

3. The method of claim 1, wherein validating each of the received input events comprises:
validating that each received input event is well-formed;
retrieving a respective schema corresponding to each received input event from the schema cache; and
validating respective data of each received input event against the retrieved respective schema.

4. The method of claim 1, further comprising:
determining that at least one of the received input events includes instruction data to update at least one of the schema cache and the subscription cache; and
updating the at least one of the schema cache and the subscription cache according to the instruction data.

5. The method of claim 1, further comprising dispatching archived events from the append-only ledger to clients.

6. The method of claim 5, wherein dispatching the archived events to the clients includes:
reading subscription information from the subscription cache;
determining which of the clients are to receive the archived events; and
determining which of the archived events are to be dispatched to the clients.

7. The method of claim 6, wherein the subscription information includes:
a client name;
a subscription name;
one or more subscribed events;
a handler type;
a handler address; and
a subscription state.

8. The method of claim 6, further comprising:
setting up a subscription fanout table and a relay fanout table;
associating a subscription fanout module with the relay fanout table; and
buffering the archived events in the subscription fanout table.

9. The method of claim 8, wherein:
the subscription fanout module inserts one partition key record into the replay fanout table for each partition key to be replayed for the clients;
for each partition key record, the subscription fanout module writes into the replay fanout table each archived event matching the partition key record, and the subscription fanout module dispatches to the clients each archived event that was written into the replay fanout table.

10. The method of claim 9, wherein the subscription fanout module dispatches events buffered in the subscription fanout table after the replay fanout table is emptied.

11. A system for maintaining an event-based database hosting service, comprising:
an input module configured to receive input events;
an append-only ledger configured to store the input events as archived events in a memory of the event-based database hosting service;
a non-transitory storage medium that stores instructions;
an output module configured to dispatch the archived events stored in the append-only ledger; and
a processing module communicatively linked with the input module, the output module, the append-only ledger, and the non-transitory storage medium; wherein execution of the instructions by the processing module cause the system to:
receive the input events on the input module;
validate each of the received input events;
provide an absolute ordering of the input events; and
append the input events to the append-only ledger according to the absolute ordering.

12. The system of claim 11, wherein the append-only ledger is a write-once-read-many ledger.

13. The system of claim 11, wherein:
the absolute ordering of the input events is based on a naming pattern that includes a partition key and a monotonically increasing identifier.

14. The system of claim 13, wherein the absolute ordering of the input events is provided by an archiver program that appends the input events to the append-only ledger as the archived events.

15. The system of claim 11, further comprising a schema cache and a subscription cache.

16. The system of claim 15, wherein to validate each of the received input events, execution of the instructions further causes the system to:
validate that each received input event is well-formed;
retrieve a respective schema corresponding to each received input event from the schema cache; and
validate respective data of each received input event against the retrieved respective schema.

17. The system of claim 16, wherein the execution of the instructions further causes the output module of the system to:
select archived events from the append-only ledger;
dispatch the selected archived events from the append-only ledger to clients.

18. The system of claim 17, wherein to dispatch the selected archived events from the append-only ledger to the clients, the instructions further cause the output module of the system to:
read subscription information from the subscription cache;
select the archived events to be dispatched using the subscription information; and
determine to which of the clients the selected archived events are to be dispatched.

19. The system of claim 18, wherein the subscription information includes:
a client name;
a subscription name;
one or more subscribed events;
a handler type;
a handler address; and
a subscription state.

20. The system of claim 18, wherein the execution of the instructions further causes the system to:
determine that at least one of the received events includes instruction data to update at least one of the schema cache and the subscription cache; and
update the at least one of the schema cache and the subscription cache according to the instruction data.
